(19) United States
(12) Patent Application Publication
(10) Pub. No.: US 2001/0049859 A1
(43) Pub. Date: Dec. 13, 2001

(54) Caster wheel assembly

(76) Inventors: Scott Lewis, Lakewood, CO (US); Mike Weege, Evergreen, CO (US); Greg Noah, Denver, CO (US)

Correspondence Address: ALAN R. THIELE, JENKENS & GILCHRIST, SUITE 3200, 1445 ROSS AVENUE, DALLAS, TX, 77002, US

(21) Appl. No.: 09/838,655

(22) Filed: Apr. 19, 2001

Related U.S. Application Data
(60) Provisional application No. 60/199,053, filed on Apr. 22, 2000.

(51) Int. Cl. B60B 19/12

(52) U.S. Cl. 16/35 D

(57) ABSTRACT

The invention relates to an apparatus and method for reducing the wobble tendency in an axle-mounted caster wheel assembly on a vehicle-mounted broom system. The caster wheel is mounted on an axle which is connected to a yoke. The yoke is attached to an upwardly extending column member. Movement of the column member is controlled by an adjustable braking mechanism located at the top of the column member.

A rigidly-mounted tubular housing surrounds the column member and a threaded rod is mounted in the top of the column member. Tightening of a jam nut located on the top of the threaded rod exerts compressive force on an expandable bushing located between the column member and the tubular housing. Such force provides frictional contact with the column member, thus reducing the movement of the column member and yoke, thereby reducing the wobble of the caster wheel assembly.

This application claims the benefit under Title 35 United States Code §119(e) of U.S. Provisional Application No. 60/199,053, filed Apr. 22, 2000.

### BACKGROUND OF THE INVENTION

1. Technical Field

This invention relates generally to methods and apparatus for managing caster wheel wobble. More particularly, this invention relates to an apparatus and method for reducing the wobble tendency in an axle-mounted caster wheel assembly on a vehicle-mounted broom or plow system. While applicable to both vehicle-mounted broom or plow systems, the invention will be described with a broom system; particularly, a snow broom system typically used for removing snow from runways at airports.

2. History of Related Art

Truck-mounted broom systems used for removing snow from the runways at airports typically include a caster wheel assembly attached to a spinning broom system which is mounted to the front of the vehicle. These caster wheels both follow the spinning broom assembly and bear part of the weight of the spinning broom assembly. During road travel to and from an airport runway, these caster wheels may have to withstand speeds of up to 50 mph. When the truck reverses direction, the caster wheel mounting should permit 180° swivel of the wheel.

In many prior art spinning broom systems, the caster wheels which follow the broom have a tendency to wobble back and forth similar to worn wheels on a grocery cart. This wobbling of the caster wheels produces overheating, premature tire wear, and frequent tire blowouts. Moreover, the caster wheels utilized in most prior art caster wheel systems are small-sized and prone to overheating and blowouts.

Wheel wobble occurs when the tire and hub are allowed to rotate freely about a vertical axis. What is needed is an apparatus which will restrict such rotation of the tire and hub in the caster wheel assembly, but which will freely permit wheel swivel on turns. Moreover, the caster wheel assembly should be able to sustain speeds of up to 50 mph. Additionally, the design of the caster wheel assembly should minimize tire overheating, premature wear, and frequent blowouts.

### SUMMARY OF THE INVENTION

The present invention is an apparatus and method for reducing the wobble tendency in an axle-mounted caster wheel assembly on a vehicle-mounted broom system. Wheel wobble occurs when the tire and hub are allowed to rotate freely about a vertical axis. The present invention utilizes a continuous friction brake assembly to reduce the wobble of the caster wheels. The caster wheel is mounted on an axle shaft between the arms of a yoke. A column extends upwardly from the top of the yoke. A tubular housing surrounds the column. The brake assembly which reduces wobble is located at the upper end of the column. A threaded rod is screwed into and welded to the top of the vertical column. A nylon bushing and two jam nuts are located at the top of the threaded rod. The tightening of the jam nuts against the nylon bushing expands the size of the bushing to exert continuous friction forces on the top of the post, thus minimizing caster wheel wobble.

### BRIEF DESCRIPTION OF THE DRAWING FIGURES

A more complete understanding of the structure and operation of the present invention may be had by reference to the following detailed description when taken in conjunction with the accompanying Drawing Figures, wherein:

FIG. 1 is a perspective view of the system and method for reducing the wobble in a caster wheel assembly of the present invention attached to a vehicle-mounted spinning broom system;

FIG. 2 is a perspective view of the top of the caster wheel assembly shown in FIG. 1;

FIG. 3 is a side elevational view of the caster wheel wobble reduction system and method; and

FIG. 4 is a front elevational view in partial cross-section of the caster wheel wobble reduction system and method.

### DETAILED DESCRIPTION OF THE PRESENTLY PREFERRED EXEMPLARY EMBODIMENT

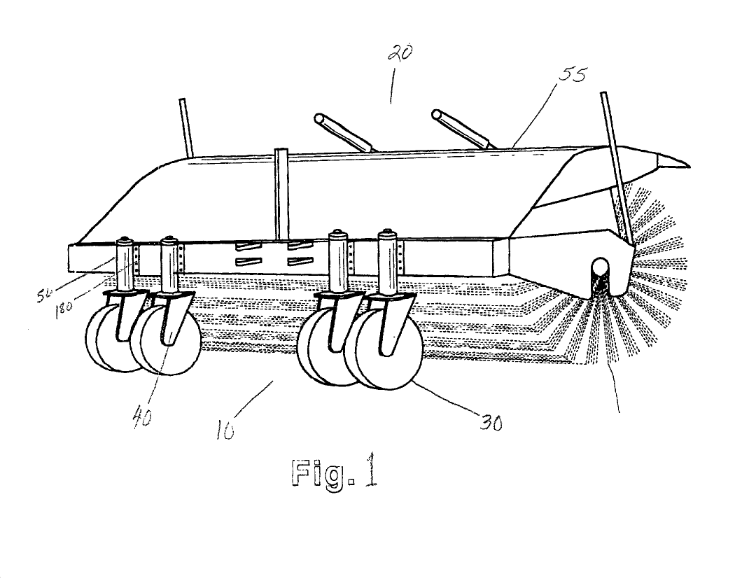

A still better understanding of the apparatus and method for reducing the wobble tendency in an axle-mounted caster wheel assembly on a vehicle-mounted spinning broom system of the present invention may be had by reference to the Drawing Figures. FIG. 1 illustrates the caster wheel assembly 10 of the present invention attached to a vehicle-mounted spinning broom system 20. The caster wheel 30 is axle-mounted between the arms of yoke 40. The yoke 40 is attached to a rigidly-mounted tubular housing 50. The tubular housing 50 is attached to the rear mounting of the broom system just below the cover assembly 55 at the mounting angles 180.

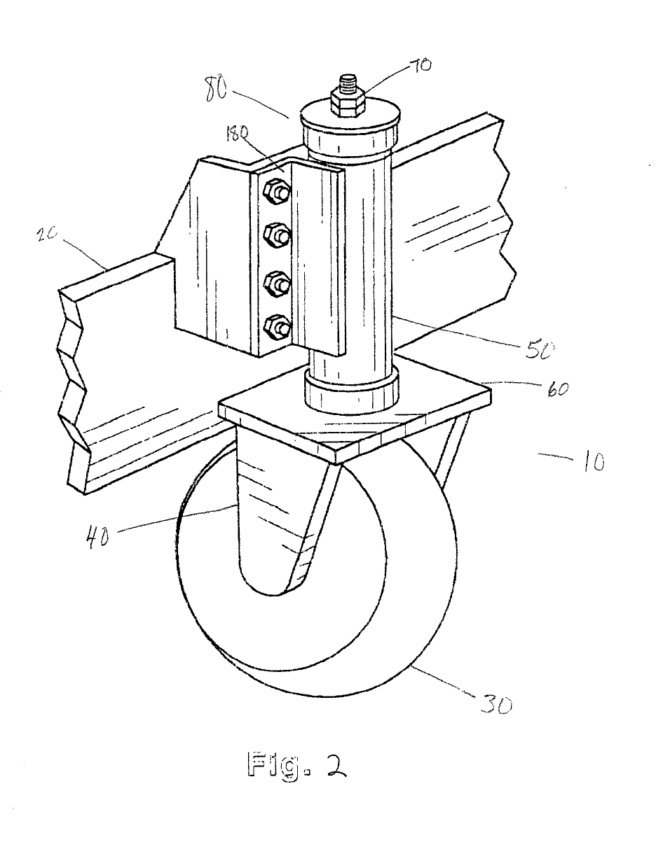

FIG. 2 illustrates a perspective view of the top of the caster wheel assembly 10 of the present invention. As can be seen in the diagram in FIG. 2, the shaft weldment 60 at the top of the yoke 40 is attached to the tubular housing 50. The mounting angles 180 connect the tubular housing 50 to the vehicle-mounted spinning broom system 20. The anti-wobble brake assembly 80 is located at the top of the tubular housing 50.

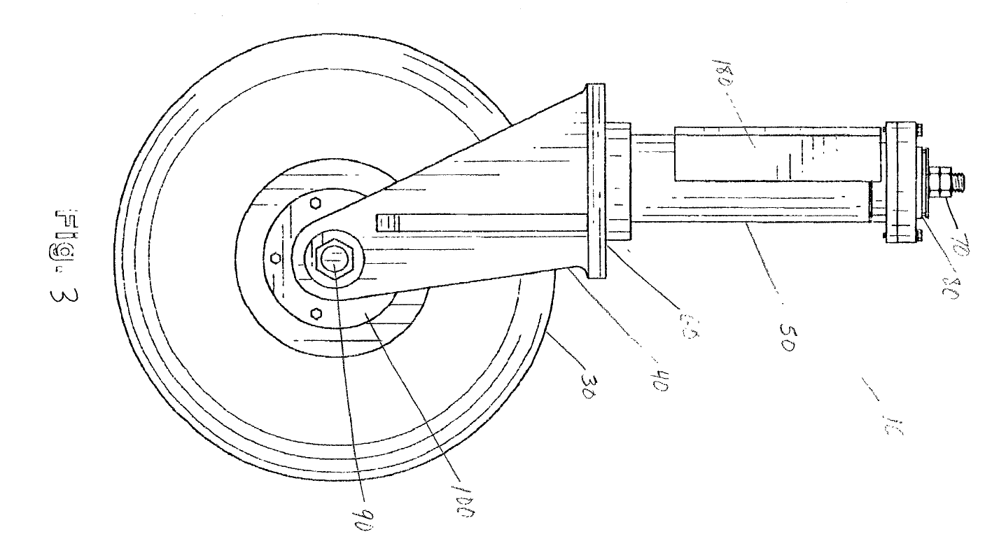

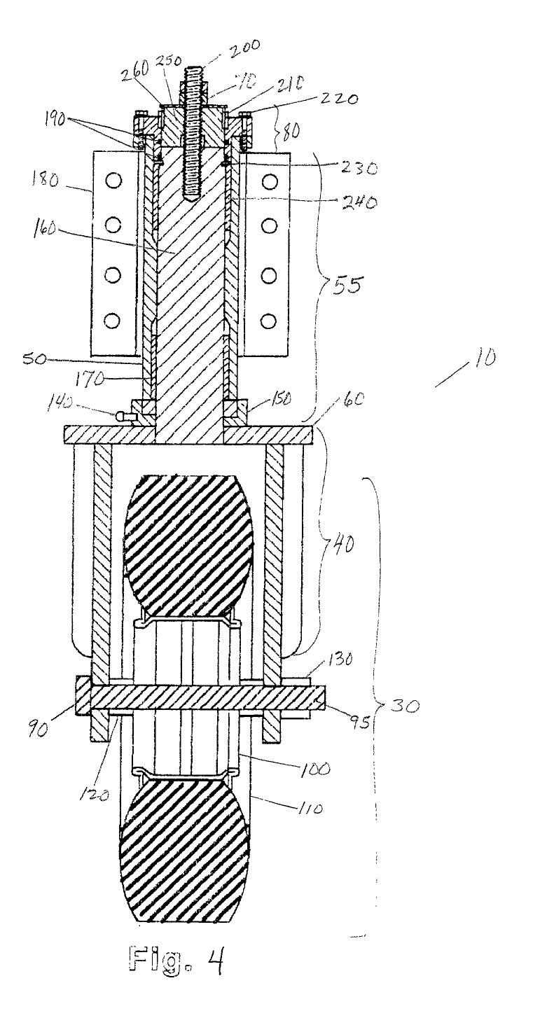

FIG. 3 is a side view of the caster wheel wobble reduction assembly 10 of the present invention. In addition to the features shown in FIG. 2, the diagram in FIG. 3 illustrates the axle shaft bolt 90 which connects the caster wheel 30 to the yoke 40 and the axle 95 (shown in FIG. 4) which is fitted through the wheel and hub assembly 100.

FIG. 4 illustrates a longitudinal cross-section of the caster wheel wobble reduction assembly 10 of the present invention. As revealed in FIG. 4, the caster wheel assembly 10 has four main parts: the caster wheel 30, the yoke 40, the column member 55, and the brake assembly 80. The tire 110 of the caster wheel 30 is mounted on the axle 95 which passes through the wheel and hub assembly 100. Sizing of the tire enables road travel of up to 50 mph. The axle 95 is connected to the yoke 40 by the axle shaft bolt 90, the axle spacers 120, and the hex nuts 130.

The shaft weldment 60 extends across the top of the yoke 40 as shown in FIG. 4. The vertical column member 160 extends upwardly from the shaft weldment 60. The antiwobble brake assembly 80 is located at the top of the column member 160. The column member 160 is surrounded by the rigidly-mounted tubular housing 50. A lower o-ring 150 and a relief fitting 140 are located at the base of the tubular housing 50. Between the column member 160 and the tubular housing 50 are an upper bushing 240 and a lower bushing 170. These two bushings enable and guide the rotation of the column member 160 within the tubular housing 50. The upper bushing 240 is secured in place by a snap ring 230.

A threaded rod 200 is embedded in the top of the column member 160. At least one jam nut 70 is located at the top of the threaded rod 200. The brake assembly 80 surrounds the threaded rod 200. A nylon bushing 250 is located on top of the column member 160 and is held in place by an upper o-ring 190, roll pins 210, caps 220, and a flat washer 260.

When the jam nut 70 is tightened, pressure is exerted on the flat washer 260. The pressure against the flat washer 260 compresses the expandable bushing 250 and causes it to expand radially against the inside of the column member 160, thereby reducing the rotation of the column member 160 within the tubular housing 50. While a variety of materials may be used, a nylon bushing has provided satisfactory results. The reduced rotation of the column member 160 results in reduced movement of the yoke 40 and concomitant reduction in caster wheel 30 wobble.

Although the invention has been described with reference to its preferred embodiment, this description is not meant to be construed in a limited sense. Various modifications of the disclosed embodiment, as well as alternative embodiments, will become apparent to persons skilled in the art upon reference to the description of the invention. It is, therefore, contemplated that the appended claims will cover such modifications that fall within the scope of the invention, or their equivalents.

What is claimed is:

1. A wobble reduction assembly for an axle mounted caster wheel comprising:
a yoke constructed and arranged for positioning the axle mounted caster wheel;
a column member extending upwardly from said yoke;
a rigidly mounted tubular housing concentrically surrounding said column member;
adjustable brake means located at the upper end of said column member;
whereby said adjustable brake means reduces the wobble of the axle mounted caster wheel by creating frictional contact with the inside of said rigidly mounted tubular housing.

2. The wobble reduction assembly as defined in claim 1 wherein said adjustable brake means includes an expandable bushing which provides the frictional contact with the inside of said rigidly mounted tubular housing.

3. The wobble reduction assembly as defined in claim 2 wherein the expansion of said expandable bushing is controlled by compressive force placed on said expandable bushing.

4. The wobble reduction assembly as defined in claim 3 wherein said compressive force on said nylon bushing is provided by the threaded engagement of a least one jam nut with a threaded rod, said threaded rod constructed and arranged for mounting in the top of said column member.

5. The wobble reduction assembly as defined in claim 1 further including at least one bushing between said column member and said rigidly mounted tubular housing.

6. A method for reducing the wobble of an axle mounted caster wheel, said method comprising the steps of:
positioning the axle mounted caster wheel in a yoke;
extending a column member upwardly from said yoke;
enclosing said column member in a rigidly mounted tubular housing;
mounting friction brake means on the opposite end of said column member from said yoke; and
causing said friction brake means to adjustably contact said rigidly mounted tubular housing.

7. The method as defined in claim 6 wherein said friction brake means includes an expandable bushing which contacts the inner surface of said rigidly mounted tubular housing.

8. The method as defined in claim 7 wherein the expansion of said expandable bushing is controlled by the compressive force on said expandable bushing.

9. The method as defined in claim 8 wherein said compressive force is placed on said expandable bushing by a jam nut threadably engaging a threaded rod, said threaded rod constructed and arranged to extend from said column member through said expandable bushing.

10. The method as defined in claim 6 further including the step of inserting at least one bushing between said column member and said rigidly mounted tubular housing.

11. A vehicle mounted system for removing unwanted material from the surface of a road or runway, said system comprising:
means for separating the unwanted material from the road or runway surface;
at least one axle mounted caster wheel assembly constructed and arranged to follow said means for separating unwanted material from the road or runway surface;
said axle mounted caster wheel assembly including:
a yoke constructed and arranged for positioning the axle mounted caster wheel;
a column member extending upwardly from said yoke;
a rigidly mounted tubular housing concentrically surrounding said column member;
adjustable brake means located at the upper end of said column member;
whereby said adjustable brake means reduces the wobble of the axle mounted caster wheel by creating frictional contact with the inside of said rigidly mounted tubular housing.

12. The vehicle mounted system as defined in claim 11 wherein said adjustable brake means includes an expandable bushing which provides the frictional contact with the inside of said rigidly mounted tubular housing.

13. The vehicle mounted system as defined in claim 12 wherein the expansion of said expandable bushing is controlled by compressive force placed on said expandable bushing.

14. The vehicle mounted system as defined in claim 13 wherein said compressive force on said nylon bushing is provided by the threaded engagement of a least one jam nut with a threaded rod, said threaded rod constructed and arranged for mounting in the top of said column member.

15. The vehicle mounted system as defined in claim 11 further including at least one bushing between said column member and said rigidly mounted tubular housing.

16. The vehicle mounted system as defined in claim 11 wherein said means for separating unwanted material from a road or runway surface is a plow.

17. The vehicle mounted system as defined in claim 11 wherein said means for separating unwanted material from a road or runway surface is a broom.

18. A caster assembly comprising:
an axle mounted wheel;
a yoke constructed and arranged to mount said axle;
a substantially cylindrical column member affixed to and extending outwardly from said yoke;
a substantially stationary tubular member constructed and arranged to concentrically surround and extend beyond the end of said substantially cylindrical column member away from said yoke;
a hollow cap constructed and arranged to both mount to and fit within said substantially stationary tubular member;
a compressible bushing constructed and arranged to fit with said hollow and friction contact the interior surface of said hollow cap;
a threaded rod constructed and arranged to threadably connect to said column member;
at least one jam nut threadably engaging said threaded rod for placing compressive force on said compressible bushing and causing said compressible bushing to impart a frictional force on the inside of said hollow cap
whereby rotating said at least one jam nut on said threaded rod will cause a compressive force to be placed on said compressible bushing, said compressive force causing said compressible bushing to exert a friction force on the inside of said hollow cap, said force on the inside of said hollow cap preventing the wobble of said axle mounted caster wheel with respect to said substantially stationary tubular member.
